(19) United States
(12) Patent Application Publication
(10) Pub. No.: US 2007/0188027 A1
(43) Pub. Date: Aug. 16, 2007

(54) Motor

(75) Inventors: Ryousuke Sakamaki, Toyohashi-city (JP); Kazuma Shibata, Hamamatsu-city (JP)

Correspondence Address: POSZ LAW GROUP, PLC, 12040 SOUTH LAKES DRIVE, SUITE 101, RESTON, VA, 20191, US

(73) Assignee: ASMO CO., LTD., Kosai-city (JP)

(21) Appl. No.: 11/705,535

(22) Filed: Feb. 13, 2007

(30) Foreign Application Priority Data
Feb. 13, 2006 (JP) 2006-035490

(51) Int. Cl. H02K 5/24; H02K 5/00

(52) U.S. Cl. 310/51; 310/89

(57) ABSTRACT

A motor includes a yoke housing, an armature, a commutator, a brush, a brush holder, and a yoke side joining part. The yoke housing has an opening. The armature is received by the yoke housing. The commutator is joined to the armature. The brush supplies electricity to the commutator. The brush holder holds the brush. The yoke side joining part connects the brush holder and the yoke housing. The yoke side joining part has an elastic member at an end part of the yoke side joining part. The end part is on a side of the yoke housing. A loss tangent of the elastic member is equal to or larger than 0.6.

### CROSS REFERENCE TO RELATED APPLICATION

This application is based on and incorporates herein by reference Japanese Patent Application No. 2006-035490 filed on Feb. 13, 2006.

### BACKGROUND OF THE INVENTION

1. Field of the Invention

The present invention relates to a motor.

2. Description of Related Art

Weight or stiffness properties of a component of a motor is conventionally increased in order to restrict vibration of a brush holder of the motor. However, the motor overall grows in size and its weight increases if the weight or stiffness properties of the component is increased. As well, rattling of the motor is conventionally reduced by decreasing a gap between the brush holder and a brush, thereby restricting generation of the vibration. Nevertheless, accuracy of the component needs to be improved to reduce the rattling of the motor, thereby causing an increase in cost.

In addition, a vibration transmission path is blocked by supporting the brush holder in a floating manner via a rubber component by a motor casing or gear housing in order to reduce the vibration of the brush holder. However, if the vibration transmission is blocked by employing a floating supporting structure using a conventional rubber component, a position of the brush holder is not set relative to an armature, so that the position of the brush holder cannot be reliably determined, since the rubber component has elasticity.

As a result, a supporting structure using a brush holder stay, in which the vibration transmission from the brush holder to the motor casing and the like is blocked by supporting the brush holder via an elastic member such as rubber, and the position of the brush holder can be more reliably determined relative to the armature, is proposed (See JP7-21085Y2).

In a motor of JP7-21085Y2, the brush holder stay, to which the brush holder is fixed, is connected to an end bracket via a rubber bush to be supported in a floating manner. The rubber bush has a plurality of concave and convex parts on its surfaces that the brush holder stay and the end bracket contact. In this manner, if the contact surface has the concave and convex parts, elastic deformation in the convex part can be transmitted to the concave part when the contact surface is pressed. Accordingly, the contact surface has a high deformation following capability, thereby restricting the vibration more reliably. Because the concave and convex parts are formed with a regular pitch and in a regular direction, the contact surface is evenly compressed in all directions and does not deform in an uneven direction. Consequently, a position of the brush holder stay can be determined more reliably.

In the motor of JP7-21085Y2, however, fine processing of the surface of the rubber bush to form the concave and convex parts causes an increase in production cost. Moreover, although the rubber bush is employed in the motor of JP7-21085Y2, it is not considered from the aspect of properties of the material, what kind of rubber is the most suitable for an elastic material. In addition, it is not proposed absorbing the vibration by inserting the elastic material such as the rubber bush between an end plate and the gear housing, which is a transfer mechanism on an output side.

### SUMMARY OF THE INVENTION

The present invention addresses the above disadvantages. Thus, it is an objective of the present invention to provide a motor, in which an elastic member that is not processed to have a special shape is employed to reliably determine positions of a brush holder and an armature, and in which an operation noise of the motor is reduced by well blocking vibration transmission from the brush holder.

To achieve the objective of the present invention, there is provided a motor, which includes a yoke housing, an armature, a commutator, a brush, a brush holder, and a yoke side joining part. The yoke housing has an opening. The armature is received by the yoke housing. The commutator is joined to the armature. The brush supplies electricity to the commutator. The brush holder holds the brush. The yoke side joining part connects the brush holder and the yoke housing. The yoke side joining part has an elastic member at an end part of the yoke side joining part. The end part is on a side of the yoke housing. A loss tangent of the elastic member is equal to or larger than 0.6.

To achieve the objective of the present invention, there is also provided a motor, which includes a yoke housing, an armature, a commutator, a brush, a brush holder, and a gear side joining part. The yoke housing has an opening. The armature is received by the yoke housing. The commutator is joined to the armature. The brush supplies electricity to the commutator. The brush holder holds the brush. The gear side joining part connects the brush holder and a gear housing that receives a transmission device. The transmission device transmits power of the motor. The armature has a rotational axis, one end of which is joined to the transmission device. The gear side joining part has an elastic member at an end part of the gear side joining part. The end part is on a side of the gear housing. A loss tangent of the elastic member is equal to or larger than 0.6.

### BRIEF DESCRIPTION OF THE DRAWINGS

The invention, together with additional objectives, features and advantages thereof, will be best understood from the following description, the appended claims and the accompanying drawings in which:

FIG. 1 is a cross-sectional view of a motor according to an embodiment of the present invention;

FIG. 2 is an illustrative cross-sectional view showing a joining area between an end plate and a yoke housing;

FIG. 3 is a graph showing a relationship between a loss tangent of an elastic member and an operation noise of the motor; and

FIG. 4 is a cross-sectional view of a motor according to another embodiment.

### DETAILED DESCRIPTION OF THE INVENTION

An embodiment of the present invention will be described below with reference to the accompanying drawings. Members, their arrangement and shapes that will be described do not limit the present invention, and can be changed in various ways in adherence with an object of the present invention.

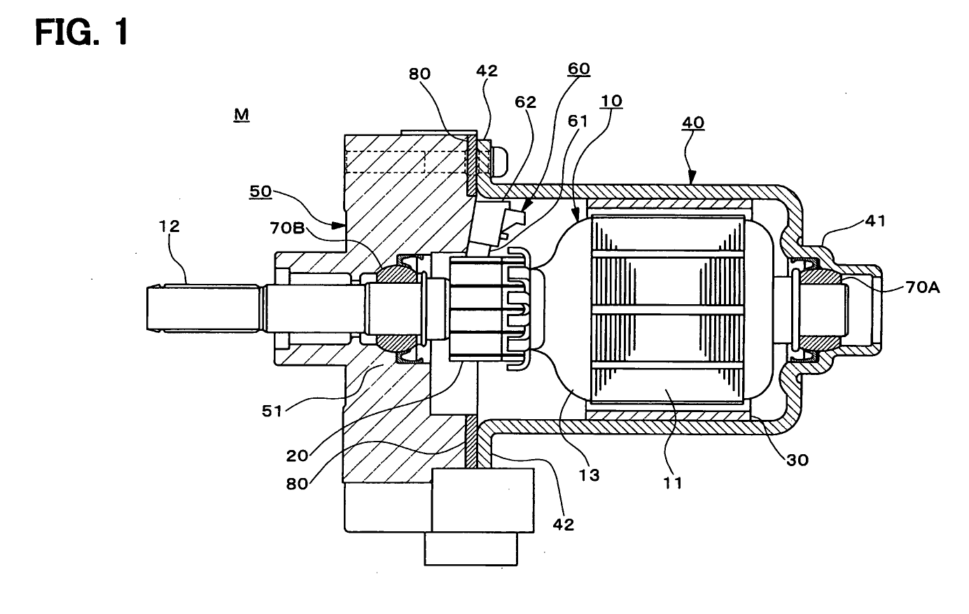

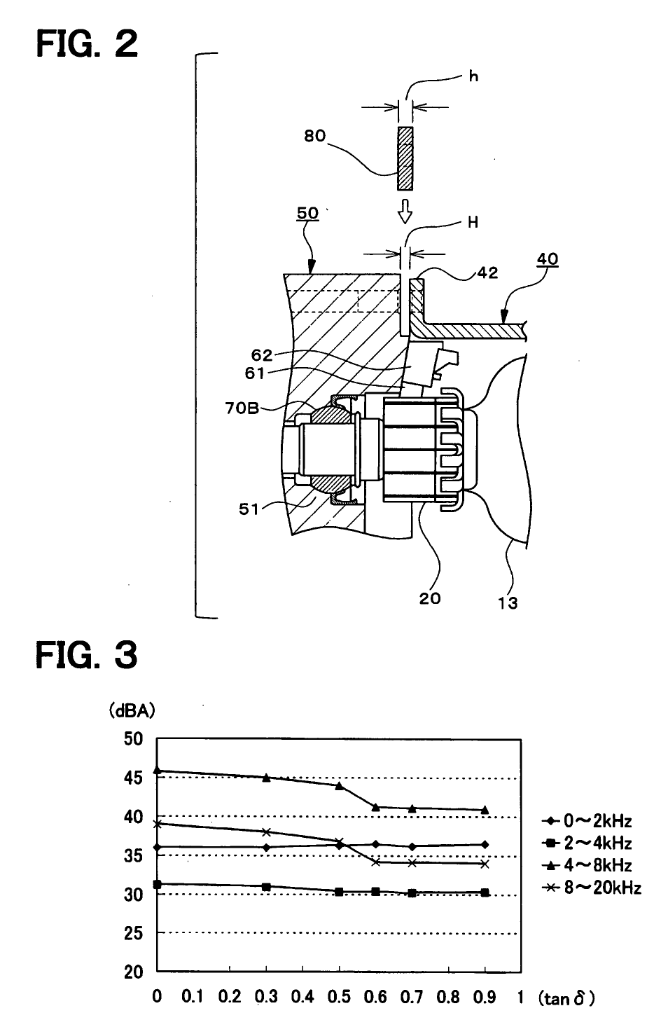

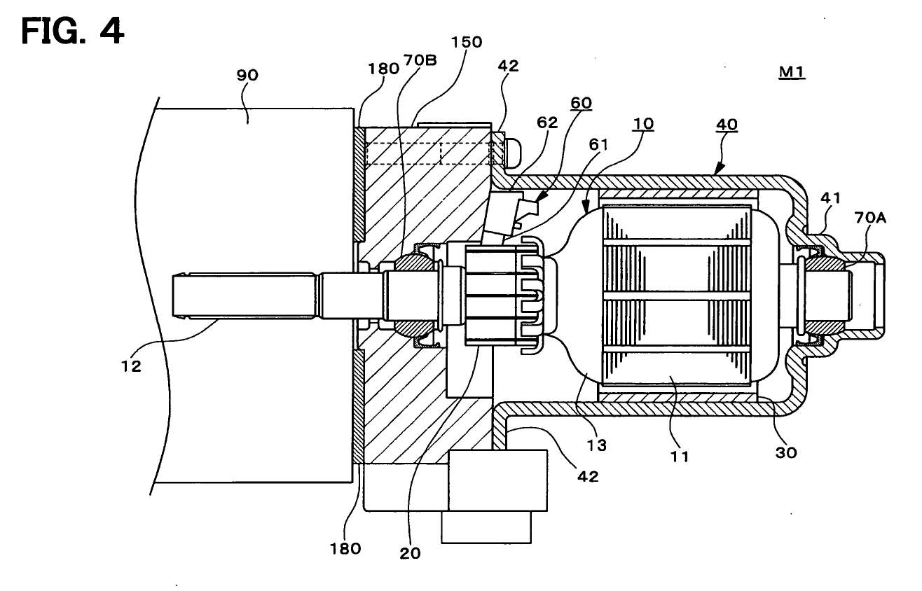

FIGS. 1 to 3 are related to the embodiment of the present invention. FIG. 1 is a cross-sectional view of a motor, FIG. 2 is an illustrative cross-sectional view (partial enlarged view of FIG. 1) showing a joining area of an end plate and a yoke housing, and FIG. 3 is a graph showing a relationship between a loss tangent (tan δ) of an elastic member and an operation noise (sound pressure: dBA) of the motor. In addition, FIG. 4 is a cross-sectional view of a motor according to another embodiment.

### First Embodiment

A configuration of a motor M according to a first embodiment of the present invention will be described with reference to FIG. 1. The motor M includes an armature 10, a stator 30, a yoke housing 40, an end plate 50, a brush apparatus 60, bearings 70A, 70B, and an elastic member 80. The armature 10 includes an armature core 11 and a commutator 20. The stator 30 is provided to surround the periphery of the armature core 11. The yoke housing 40 receives the armature 10 and the stator 30. The end plate 50 blocks an opening of the yoke housing 40 on a side of the commutator 20. The brush apparatus 60 includes a brush 61 that is in sliding contact with the commutator 20, and is fixed to the end plate 50. The bearings 70A, 70B are provided in the yoke housing 40 and the end plate 50 respectively. The elastic member 80 is placed between the yoke housing 40 and the end plate 50.

The armature 10 has a shaft 12 that rotates, and the armature core 11 and the commutator 20 are fixed to the shaft 12 next to each other. The armature core 11 has, for example, a plurality of slots that extend in a radial direction of the shaft 12. Windings 13 are wound along the slots in a predetermined manner.

The commutator 20 has a plurality of commutation segments, which include an electrically conductive metal and the like, on its outer circumferential surface. The commutation segments are insulated from each other in a circumferential direction of the commutator 20 by a commutator slot, and are connected to the corresponding windings 13 extending outwards from an armature core 11 side.

The stator 30 includes magnets of the different polarity, which are alternately arranged in a circumferential direction of the armature 10 to generate a predetermined magnetic field at the armature 10. The stator 30 is opposed to the windings 13 that are wound around the armature core 11 with a predetermined gap therebetween.

The yoke housing 40 is made from metal, and has a cylindrical shape with a bottom part. A bearing attaching portion 41 is formed in a generally central area of the bottom part and projects from the bottom part. The bearings 70A, which support one end of the shaft 12, are placed inside the bearing attaching portion 41. The bearings 70B to support the other end of the shaft 12 are placed at a bearing attaching portion 51, which is placed in a generally central area of the end plate 50. The other end of the shaft 12, which extends outside from a hole of the end plate 50 toward outside, is an output shaft of the motor M and is connected to a power transmission mechanism such as a gear. The end plate 50 is connected to an apparatus that uses the motor M as a driving source, that is, to a gear housing (not shown), which receives the gear and the like. In addition, the end plate 50 may be integrated with the gear housing on an apparatus side.

A flange part 42, which extends outwards in a radial direction of the shaft 12, is formed at an opening of the yoke housing 40. A fastening hole for jointing is formed at a predetermined position of the flange part 42. The flange part 42 comes into contact with an outer circumferential part of the end plate 50 via the plate-like elastic member 80, which will hereinafter be described in detail. The elastic member 80 and the end plate 50 have respective fastening holes at positions corresponding to the fastening hole of the flange part 42.

The end plate 50 is made from resin, and as will be described below, the brush apparatus 60 is fixed to the end plate 50. In this example, the plate-like elastic member 80 is inserted between the flange part 42 and the end plate 50 such that their respective fastening holes overlap, and they are jointed by screwing a fastening member such as a screw into the fastening holes. Alternatively, the flange part 42, the end plate 50 and the elastic member 80 may be swaged together with a rivet or the like instead of the screw. As a result, the end plate 50 is fixed to the yoke housing 40 via the elastic member 80, and the opening of the yoke housing 40 is blocked. Also, the end plate 50 and the brush apparatus 60 are supported in a floating manner via the elastic member 80 by the yoke housing 40.

The brush apparatus 60 has the brush 61, which is provided to contact a surface of the plurality of commutation segments, and a brush holder 62, which holds the brush 61. As shown in FIG. 1, the brush apparatus 60 of the present example is placed on an inner circumferential side of a joining area of the yoke housing 40 and the end plate 50.

The brush 61 is constantly urged against the surfaces of the commutation segments by pressing force of a coil spring, a plate spring or the like, which is provided in the brush holder 62. Accordingly, when the commutator 20 rotates, the brush 61 is in elastically sliding contact with the surfaces of the commutation segments. The brush 61 and brush holder 62 are appropriately placed at a predetermined position on a surface of the end plate 50 on a yoke housing 40 side, and they may be generally symmetrically placed at two positions with the commutator 20 being their center, for example. In the cross-sectional view of FIG. 1, cutting surfaces on both sides of the commutator 20 are set at a position where there are the brush 61 and brush holder 62, and at a position where there are not the brush 61 or brush holder 62.

As well, in the present example, the brush holder 62 is fixed via a predetermined joining part to determine its position to be a predetermined position relative to the armature 10 and commutator 20. More specifically, the brush holder 62 is fixed on the surface of the end plate 50 on the yoke housing 40 side, and as described above, the end plate 50 is jointed to the yoke housing 40 via the elastic member 80. That is, the end plate 50 and the elastic member 80 correspond to a yoke side joining part of the present invention, and the brush holder 62 is fixed to determine its position relative to the armature 10 and commutator 20 by being joined to the yoke housing 40 via the yoke side joining part.

In addition, instead of forming the end plate 50 and the brush holder 62 as different members to be jointed together, they may be integrally formed to be a brush holder that serves as an end plate as well.

Next, the elastic member 80, which is a characteristic component of the present invention, will be described below.

As shown in FIG. 1, the elastic member 80 is placed on the surface of the end plate 50, which faces in an axial direction of the shaft 12, and consequently, the end plate 50, the elastic member 80, and the flange part 42 are arranged in the axial direction of the shaft 12 sequentially.

The elastic member 80 is formed to be plate-like, and its thickness is set, such that the elastic member 80 can be compressed with the elastic member 80 inserted between the end plate 50 and the flange part 42 and jointed to the end plate 50 and the flange part 42. That is, as shown in FIG. 2, the thickness of the elastic member 80 is set, such that a gap size H of a gap between the flange part 42 and the end plate 50 is smaller than the thickness h of the elastic member 80 before the elastic member 80 is jointed to the end plate 50 and the flange part 42, that is, when the elastic member 80 is not pressed.

By virtue of this structure, since the elastic member 80 is compressed when the elastic member 80 is jointed, the elastic member 80 closely contacts and is fixed to the end plate 50 and the flange part 42 by restoring force that corresponds to properties of the elastic member 80. Because the elastic member 80 is compressed and deformed to closely contact the end plate 50 and the flange part 42, rattling due to dimension errors of the members, and the like, can be restricted, and it can be ensured that vibration, which is transmitted from the brush apparatus 60 to the end plate 50, is transmitted to the elastic member 80.

When the restoring force of the elastic member 80 is great, it is further ensured that the elastic member 80 closely contacts and is fixed to the end plate 50 and the flange part 42, and that the position of the brush apparatus 60 is determined relative to the armature 10 and commutator 20.

In the structure of the motor M, the vibration of the brush apparatus 60 is generated because the brush 61 is elastically pressed against and in sliding contact with the surfaces of the commutation segments when the armature 10 and commutator 20 rotate as a result of external electronic power supply. This vibration is directly transmitted to the yoke housing 40 if the elastic member 80 does not exist in a vibration transmission path from the end plate 50 to the yoke housing 40, so that the end plate 50 directly contacts and is rigidly jointed to the yoke housing 40. Accordingly, when the elastic member 80 is not used, noises such as a frictional sound and rattling sound between the members are loud, thereby increasing the operation noise of the motor.

However, when the end plate 50 and the brush apparatus 60 are supported in a floating manner via the elastic member 80, the vibration is absorbed according to the properties of the elastic member 80, and a vibration blocking effect that corresponds to the properties of the elastic member 80 can be produced. Consequently, a range of the vibration can be narrowed down and a vibration level can be decreased, thereby reducing the operation noise of the motor.

In the present example, a particular dumping material, that is, a material that has a predetermined modulus of restitution elasticity and a predetermined loss tangent is selected and used as the elastic member 80. Through various investigations that focus on the loss tangent and the modulus of restitution elasticity as the properties of the elastic member, it is verified that vibrational absorption performance is high when the loss tangent is large, and the modulus of restitution elasticity is small. More specifically, it is verified that an obviously stronger effect of reducing the operation noise can be produced by setting the loss tangent at a value, which is equal to or larger than 0.6, than when the loss tangent is smaller than 0.6. Furthermore, it is verified that a strong effect of reducing the operation noise can be produced when the modulus of restitution elasticity is equal to or smaller than 35%.

FIG. 3 is a graph showing data on a relationship between the loss tangent (tan δ) and the sound pressure (dBA) of the operation noise of the motor in the structure of the motor M in FIG. 1 based on actual measurement. In the graph, the data when the loss tangent is 0 (zero) is the measured data on motors in which the elastic member 80 is not inserted.

The loss tangent discussed in the present specification is an index that is measured by a dynamic characteristic test, which is prescribed in Japanese Industrial Standards (JIS) K 6385. The loss tangent indicates buffering properties such as a vibration isolating material and the dumping material, and indicates how much energy a material absorbs through deformation to turn the energy into heat when predetermined vibration is given. Also, the modulus of restitution elasticity discussed in the present specification is an index that is measured by a restitution elasticity test, which is prescribed in JIS K 6255. The modulus of restitution elasticity indicates an energy ratio between before and after the collision when a predetermined object collides with a material specimen under predetermined conditions.

As shown in the graph, in the motor M, which is provided with the elastic member 80 using the structure of the present example, when the loss tangent varies from 0.6 to 0.5, a level of the sound pressure of the operation noise changes obviously more considerably than at any other range of the loss tangent at a frequency of 4 kHz to 8 kHz, and at a frequency of 8 kHz to 20 kHz. That is, at a large part of an audible frequency (i.e., approximately 3 to 10 kHz), when the loss tangent is equal to or larger than 0.6, the operation noise (sound pressure) is obviously lower than when the loss tangent is equal to or smaller than 0.5.

In the present example, based on the above actual measurement results, butyl rubber or polynorbornene rubber is used for forming the elastic member 80 as a particular dumping material that has properties of the loss tangent being equal to or larger than 0.6 and the modulus of restitution elasticity being equal to or smaller than 35%. By using the particular dumping material in this manner, the vibration transmitted from an end plate 50 side is well damped by the elastic member 80. Accordingly, the vibration of members on the yoke housing 40 side is restricted, and the operation noise is reduced. In addition, such a particular dumping member has a high deformation following capability. Consequently, even though the elastic member 80 closely contacts the end plate 50 and is already compressed as described above, the vibrational absorption performance does not decline, thereby well damping the vibration. As a result, it can be ensured that the position of the brush apparatus 60 is determined and that the operation noise is reduced.

On the other hand, when rubber, the vibrational absorption performance of which is not very high, exists between the brush apparatus and its fixing member as in the conventional example, the vibrational absorption performance declines because the rubber is inserted by compressing it so that the rubber closely contacts the fixing member. Hence, the vibration cannot be reliably removed.

Additionally, the dumping material, which is used as the elastic member 80 of the present invention, is not limited to the butyl rubber or polynorbornene rubber, and any material, which has the properties of the loss tangent being equal to or larger than 0.6 and the modulus of restitution elasticity being equal to or smaller than 35%, may be used as the elastic member 80.

### Second Embodiment

In the first embodiment above, by inserting the elastic member 80 between the yoke housing 40 and, the brush apparatus 60 and the end plate 50, vibration transmission is restricted. Nevertheless, the vibration transmission path from the brush apparatus 60 and the end plate 50 to the other members leads not only to the yoke housing 40 side but to a joining area of the end plate 50 and the gear housing, which is jointed on an opposite side of the yoke housing 40.

Accordingly, in a motor M1 of a second embodiment, as shown in FIG. 4, an end plate 150 is jointed via a plate-like elastic member 180 to a housing on a side of an apparatus, which uses the motor M1 as a driving source, that is, to a gear housing 90 to receive a gear and the like that are connected to the shaft 12, which is an output shaft of the motor M1. As a result, the gear housing 90, the elastic member 180, and the end plate 150 are arranged in the axial direction of the shaft 12 sequentially. The brush holder 62 is connected to the gear housing 90 via a gear side joining part that includes the end plate 150 and the elastic member 180.

The elastic member 180 of the second embodiment is formed from a dumping material, which is the same as the material used in the first embodiment, and has properties of the loss tangent being equal to or larger than 0.6 and the modulus of restitution elasticity being equal to or smaller than 35%. In addition, the elastic member 180 is thicker than a gap between the gear housing 90 and the end plate 150.

By virtue of this structure, the elastic member 180 closely contacts the gear housing 90 as well as the end plate 150, so that vibration transmission to the gear housing 90 can be reliably restricted, thereby restricting the operation noise. Besides, the positions of the end plate 150 and the brush apparatus 60 can be reliably determined relative to the gear housing 90.

Additionally, the elastic member 80 and the elastic member 180 may be inserted in a joining area between the end plate 150 and the yoke housing 40, and a joining area between the end plate 150 and the gear housing 90, respectively. Furthermore, if the brush apparatus 60 is jointed to another member, the elastic member 80 may be inserted therebetween to restrict the operation noise more reliably.

Additional advantages and modifications will readily occur to those skilled in the art. The invention in its broader terms is therefore not limited to the specific details, representative apparatus, and illustrative examples shown and described.

What is claimed is:

1. A motor comprising:
a yoke housing that has an opening;
an armature that is received by the yoke housing;
a commutator that is joined to the armature;
a brush that supplies electricity to the commutator;
a brush holder that holds the brush; and
a yoke side joining part that connects the brush holder and the yoke housing, wherein the yoke side joining part has an elastic member at an end part of the yoke side joining part, wherein:
the end part is on a side of the yoke housing; and
a loss tangent of the elastic member is equal to or larger than 0.6.

2. The motor according to claim 1, wherein:
the yoke side joining part has an end bracket that blocks the opening of the yoke housing, and the elastic member that is placed in a gap between the end bracket and the yoke housing; and
the brush holder is fixed on a predetermined position of the end bracket.

3. The motor according to claim 2, wherein:
the elastic member has a plate-like shape;
thickness of the elastic member is larger than a size of the gap between the end bracket and the yoke housing; and
the yoke housing, the elastic member, and the end bracket are sequentially arranged in a direction of a rotational axis of the armature.

4. The motor according to claim 1, wherein a modulus of restitution elasticity of the elastic member is equal to or smaller than 35%.

5. A motor comprising:
a yoke housing that has an opening;
an armature that is received by the yoke housing;
a commutator that is joined to the armature;
a brush that supplies electricity to the commutator;
a brush holder that holds the brush; and
a gear side joining part that connects the brush holder and a gear housing that receives a transmission device, wherein:
the transmission device transmits power of the motor;
the armature has a rotational axis, one end of which is joined to the transmission device; and
the gear side joining part has an elastic member at an end part of the gear side joining part, wherein:
the end part is on a side of the gear housing; and
a loss tangent of the elastic member is equal to or larger than 0.6.

6. The motor according to claim 5, wherein:
the gear side joining part has an end bracket and the elastic member, wherein:
the end bracket blocks the opening of the yoke housing and has a hole, in which the one end of the rotational axis of the armature is inserted; and
the elastic member is placed in a gap between the end bracket and the gear housing; and
the brush holder is fixed on a predetermined position of the end bracket.

7. The motor according to claim 6, wherein:
the elastic member has a plate-like shape;
thickness of the elastic member is larger than a size of the gap between the end bracket and the gear housing; and
the gear housing, the elastic member, and the end bracket are sequentially arranged in a direction of a rotational axis of the armature.

8. The motor according to claim 5, wherein a modulus of restitution elasticity of the elastic member is equal to or smaller than 35%.
